(19) United States
(12) Patent Application Publication
(10) Pub. No.: US 2007/0247017 A1
(43) Pub. Date: Oct. 25, 2007

(54) Axial-Flux, Permanent Magnet Electrical Machine

(75) Inventor: James Richard Bumby, Durham (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: University of Durham

(21) Appl. No.: 11/579,464

(22) PCT Filed: May 19, 2005
(86) PCT No.: PCT/GB05/01960

§ 371 Date: Nov. 3, 2006

(30) Foreign Application Priority Data
May 29, 2004 (GB) 0412085.3

(51) Int. Cl. H02K 21/00

(52) U.S. Cl. 310/268

(57) ABSTRACT

An axial flux, permanent magnet electrical machine is disclosed. The machine has at least one stator disc and at least one rotor disc co-axial with the stator disc and mounted for rotation relative to the stator disc. The rotor has a plurality of permanent magnets mounted circumferentially thereon, and the stator comprises a plurality of discrete windings. The windings are recessed in the stator. The stator disc can be formed from a plastics material, and the rotor can have a segmented construction. The windings can also be arranged in groups to provide for a multi-phase machine.

The present invention relates to electrical machines, more particularly to an axial-flux, permanent magnet machine and most particularly to an axial-flux, permanent magnet generator.

The general concept of axial-flux motors and generators is not in itself a new idea with Campbell (1) responsible for much of the pioneering work on these types of machines in the 1970's. In his machine Campbell used ferrite magnets and brushed armature windings. With the recent availability of high strength, rare earth permanent magnets (PM) and the development of power electronics there has been a new interest in brushless versions of these types of machine (2). It is now usual to use high-remanence, Neodymium-Iron-Boron (NdFeB) permanent magnets.

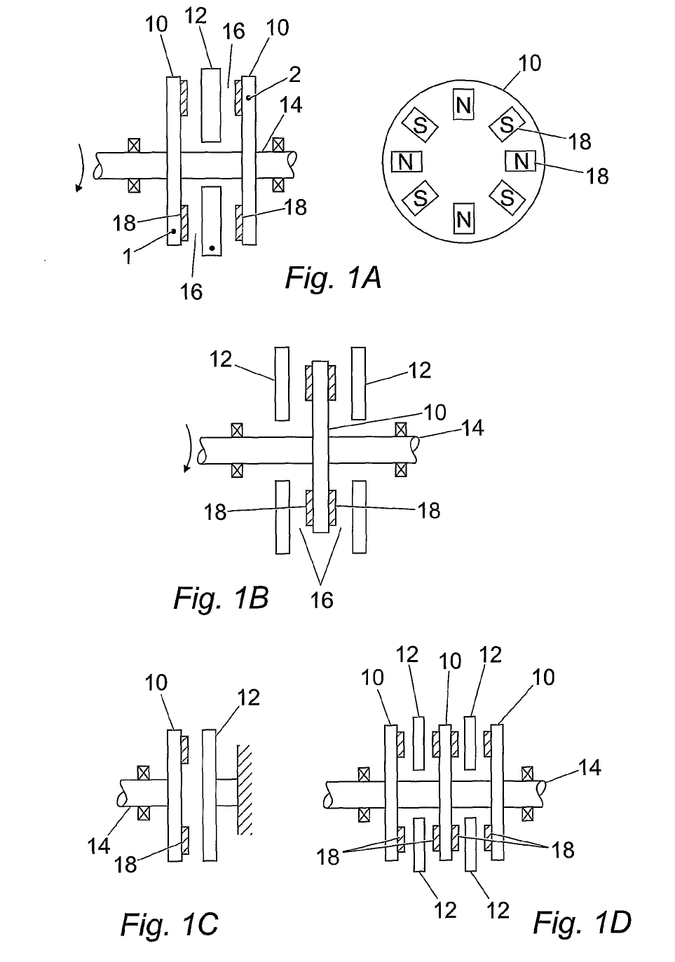

As shown in FIG. 1 of the accompanying drawings, PM axial-flux machines consist of a number of generally planar rotor discs 10 and stator discs 12 mounted axially along a shaft 14 with each stator and rotor disc separated by a small air-gap (or running clearance) 16. The magnets 18 are mounted circumferentially round the rotor discs with alternating north and south poles facing the stator. The rotor discs rotate relative to the stator discs. A 2 rotor/1 stator disc combination (FIG. 1A) is probably the most common (2) but there can be any number of stator and rotor discs; for example a generator manufactured by Turbogenset has a large number of stator and rotor discs (8). FIG. 1B shows a 1 rotor/2 stator combination, FIG. 1C shows a 1 rotor/1 stator combination and FIG. 1D shows a 3 rotor/2 stator combination.

The stator disc 12 can be made from a non-magnetic, non-conducting material or from a laminated magnetic material. The armature winding (not shown in FIG. 1) is wound on the stator 12 and can be located either in slots or as a surface mounted air-gap winding. The armature winding can be either wound as a conventional distributed winding (6), concentrated winding (3) or wound toroidally round the iron stator core (2, 5).

Axial flux machines tend to have a larger diameter and shorter axial length than equivalently radial flux counterparts and therefore tend to be attractive in applications that demand machines of short axial length; for example as in-wheel motors (6,7) or for use with internal combustion engines when the generator can be mounted directly on the engine in place of the flywheel (5).

Of particular note is the axial flux toroidal generator. This machine normally consists of two rotor discs 10 and one stator disc 12, as in FIG. 1A. The stator 12 is manufactured from a strip wound iron core and the armature windings are wound toroidally around the outside of the core. Such a machine has been developed at the University of Durham and elsewhere and has been used in engine/generator sets (5) and as a wind turbine generator (3,4).

At the University of Durham there have been designed and built a number of different axial flux machines for different applications. More recently these machines have been used as wind turbine generators. In this application there have been used:
Generators with toroidal air-gap armature windings
Generators with concentrated coils placed in the air-gap (3)

A common feature of both these machines is that the armature coils are located in the air-gap. In this position the armature coils are very well cooled but are very exposed mechanically and vulnerable to damage if the rotating magnets should touch them. Experience with two different types of vertical axis wind turbines has shown that it is difficult to maintain, at all times, the running clearance between the spinning rotor discs and the stator so that the armature winding is easily damaged. In addition, with some vertical axis wind turbines mounting and de-mounting the generator is not straightforward and a generator design that allows for this would be welcomed.

Consequently the generator of the present invention has been developed with the following points in mind:
Simple, low cost construction
A robust armature structure
A machine that can be readily manufactured and assembled by a small mechanical workshop with little or no electrical engineering knowledge
Rotor and stator structures that can both be made in two or more segments if required (for ease of mounting)

The present invention provides an improved axial-flux, permanent magnet machine. In its various aspects, the invention variously includes the following features:
Use of recessed windings, so that the coils are well protected from mechanical damage.
Bobbin windings can be used so that the windings are easy to wind and replace.
Use of plastic (e.g. PVC) stator support.
Stator and rotors can be made in segments if required.
Switchable winding connections enabling multi-phase machines with switchable output voltage.

In accordance with a first aspect of the invention, there is provided an axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having a plurality of discrete windings, the windings being mounted circumferentially on the stator or rotor disc and recessed into a surface of the stator or rotor disc.

Preferably, the rotor has a plurality of permanent magnets mounted circumferentially thereon and the stator has a plurality of discrete windings, the windings being mounted circumferentially on the stator disc and recessed into a surface of the stator disc.

Preferably, the windings are wound on bobbin members.

Optionally, the windings are embedded in the stator or rotor structure, most preferably fixed in place by a resin material.

In accordance with a second aspect of the invention, there is provided an axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having at least one winding, wherein at least one of the stator disc and the rotor disc is of segmented construction to facilitate assembly and dis-assembly of the discs to and from a supporting shaft.

Preferably, the rotor has a plurality of permanent magnets mounted circumferentially thereon and the stator has at least one winding.

In accordance with a third aspect of the invention, there is provided an axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having at least one winding, wherein the rotor or stator disc is formed from a non-magnetic, non-conducting material.

Preferably, the rotor or stator disc is formed from a plastics material, suitably PVC.

Preferably, the rotor or stator disc is formed from a resin material.

Preferably, the rotor has a plurality of permanent magnets mounted circumferentially thereon and the stator has at least one winding, wherein the stator disc is formed from a non-magnetic, non-conducting material.

In accordance with a fourth aspect of the invention, there is provided an axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having a plurality of discrete windings mounted circumferentially thereon, the windings being arranged in one or more groups, the windings of each group being inter-connected by switching means whereby the windings of each group may be selectively connected in series or in parallel.

Preferably, the rotor has a plurality of permanent magnets mounted circumferentially thereon and stator has a plurality of discrete windings mounted circumferentially on the stator disc.

The switching means may further enable sub-groups of windings of each group to be connected in parallel and sub-groups to be connected together in series.

In accordance with a fifth aspect of the invention, there is provided a wind-turbine including a machine in accordance with any of the first to fourth aspects of the invention, said machine being configured as a power generator. Preferably, the turbine has a vertical axis shaft and a plurality of blades, the generator being located on said shaft below said blades. The machine may also be used with horizontal axis turbines.

Embodiments of the invention will now be described, by way of example only, with reference to the accompanying drawings in which:

FIG. 1 schematically illustrates a variety of prior art axial-flux machines;

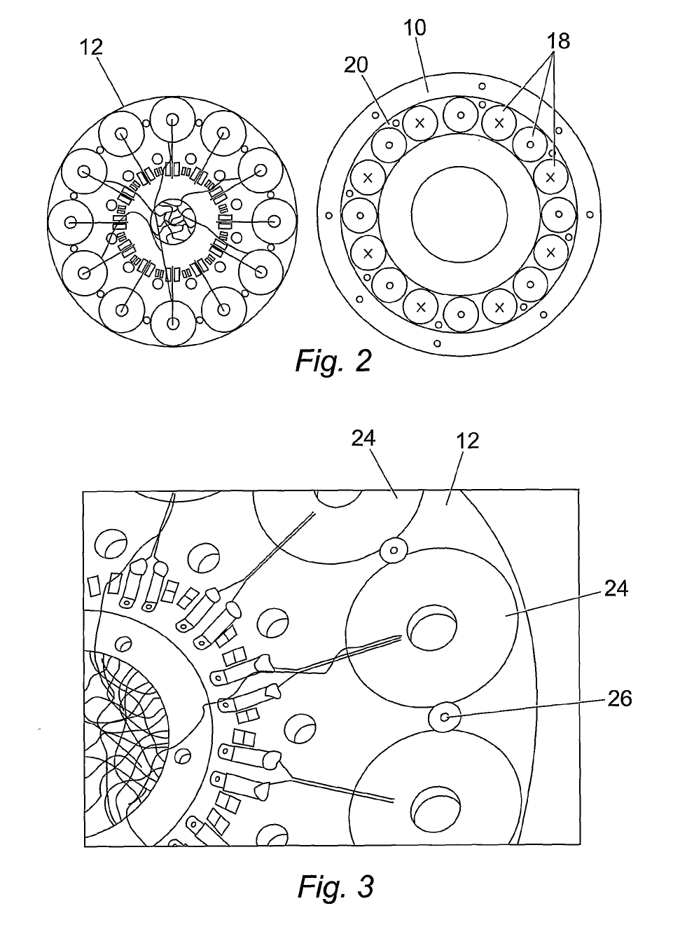

FIG. 2 shows a stator disc and a rotor disc of one embodiment of the present invention;

FIG. 3 is a detail view of bobbin windings mounted in the stator disc of FIG. 2;

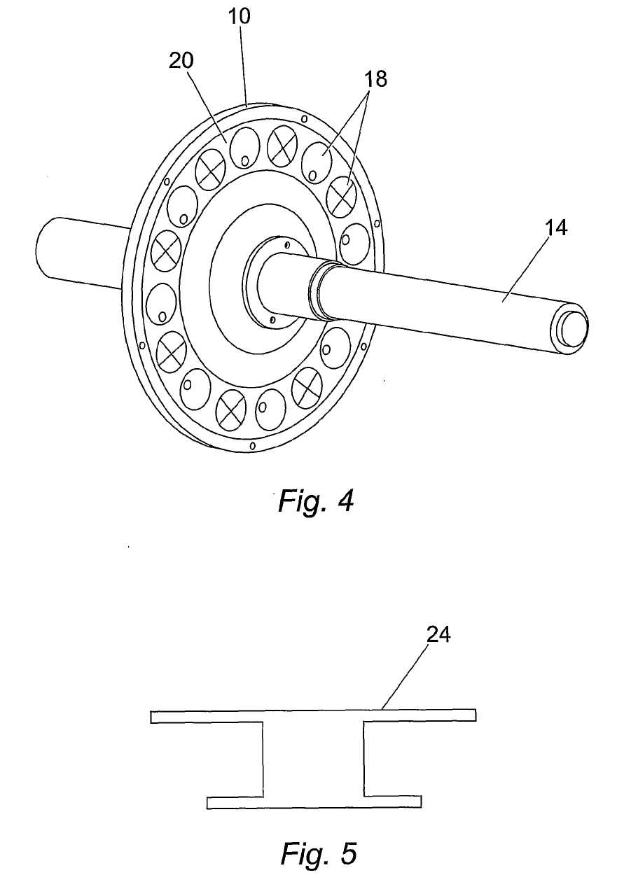

FIG. 4 is a perspective view of the rotor disc of FIG. 2 mounted on a shaft;

FIG. 5 illustrates the transverse cross-sectional shape of the bobbins of the stator disc;

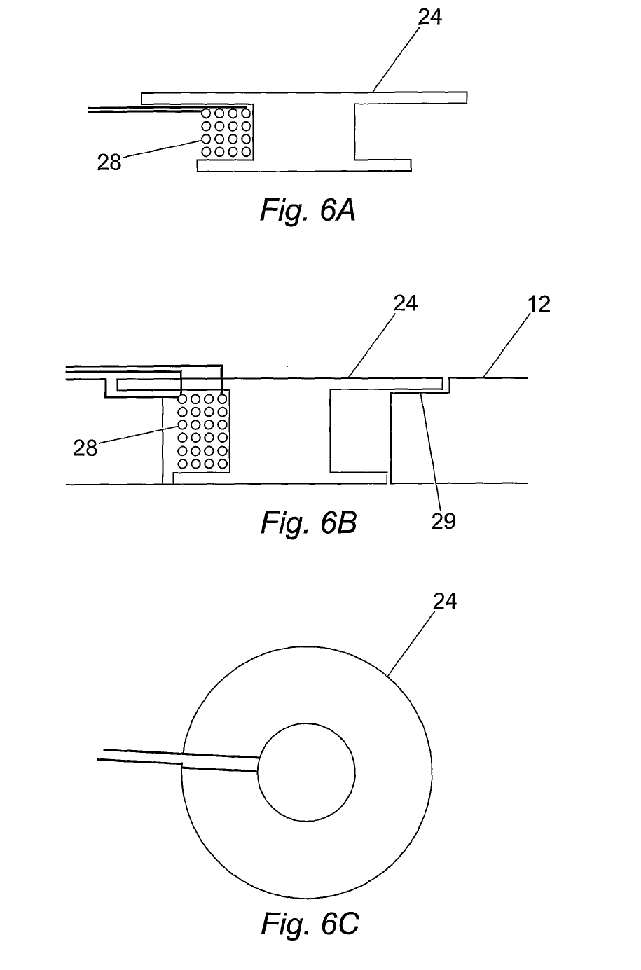

FIG. 6 illustrates the winding of a coil on the bobbin of FIG. 5;

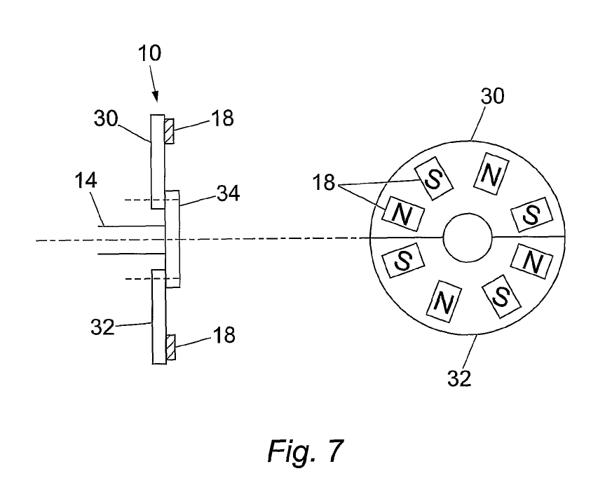

FIG. 7 illustrates one example of a segmented construction of a rotor disc.

The essential features of the various aspects of the invention are applicable to axial-flux, permanent magnet machines having any of a variety of configurations of stator and rotor discs, such as those illustrated in FIG. 1. In a preferred embodiment, the machine has two rotor discs 10 and one stator disc 12 (i.e. an arrangement generally similar to that of FIG. 1A). Each rotor disc 10 is aligned with the other rotor disc so that a North pole of a magnet 18 on one disc faces a South pole of a magnet 18 on the other disc. A picture of one of the rotor discs 10 and the stator disc 12 of the preferred embodiment of the invention is shown in FIG. 2.

The magnets 18 are located around the rotor disc 10 in a N-S-N arrangement (as also seen in FIG. 1). The rotor disc 10 is made from a magnetic material, usually mild steel. Although round magnets are shown they could be round, rectangular, arc-shaped, trapezoidal or any other suitable shape. The magnets are held in place by magnetism to the rotor disc 10 and may also be glued. The magnets 18 are further restrained against centrifugal forces by being located in apertures in a retainer strip 20 of non-magnetic material (suitably a plastic such as PVC, but any non-magnetic material can be used) secured to the surface of the rotor disc by screws or the like. A completed rotor disc 10 mounted on the shaft 14 is shown in FIG. 4.

The stator disc 12 is made from a non-magnetic, non-conducting, material. For cheapness, in accordance with one aspect of the invention, a plastic material such as PVC is preferred. The stator disc 12 could also be made from a plastics material such as a resin. Holes (not shown) are machined in the disc 12 to accept a number of discrete windings 24.

Another construction option is for a plurality of discrete windings to be placed at regular intervals around an annular ring, which is then filled with resin. This is suitable for use in water turbines, where the machine may be immersed in water.

In one embodiment, the windings are in the form of bobbin windings 24. The bobbins 24 are located in the holes as shown in FIG. 3. The bobbins 24 are shaped as shown in FIG. 5 with the diameter of the top flange of the bobbin 24 greater than the bottom so that the bobbin does not fall through the stator 12. That is, the smaller diameter part of the bobbin 24 fits within the hole in the stator 12, with the larger diameter flange abutting against the stator surface adjacent the hole, recessed in a shoulder 29 (FIG. 6B) surrounding the hole so that the top surface of the larger diameter flange is flush with the main surface of the stator disc 12.

In this example the bobbins 24 are held in place by small screws 26 but the bobbins 24 can be made to be a push fit that locks into place. Alternatively the bobbins could be made with a screw thread.

The bobbins 24 are made from a non-magnetic, non-conducting material, preferably a plastic material. In this instance the material used is acetal because of its machining properties.

A copper winding 28 is wound on the bobbin and its ends are terminated as shown in FIG. 3.

The bobbin itself has a small radial cut or slot in it so that the start of the copper winding does not take up useful winding space, see FIGS. 3 and 6. FIG. 6A shows how the ends of the winding would occupy useful space without such a cut, while FIG. 6B shows how the ends may exit the bobbin via a slot in the top flange, as also seen in FIG. 3.

Alternatively, instead of fixing bobbin members to the stator disc 12, the windings can be directly embedded in the stator disc 12. In this case the windings can be fixed in place by a resin material, which also provides mechanical protection. A cover plate can also be provided to give further mechanical protection. The windings can be formed on a bobbin member before being removed and inserted directly into the holes in the stator disc.

Generally speaking, the details of the wiring and control electronics etc. of the machine will be well understood by persons of ordinary skill in the art and will not be described herein. However, in accordance with one aspect of the invention, it is preferred that the individual windings are arranged in one or more groups and that the windings of each group are interconnected by means of switches (not shown, such as power transistors). This enables the windings of each group to be selectively connected in series or in parallel, or for sub-groups of windings to be connected in parallel and the sub-groups connected in series. The output voltage of the machine can thus be selected by selecting from a variety of possible winding connections. In the illustrated example, there are twelve windings, arranged in groups of four to provide a three-phase machine. The four windings of each phase can be connected in series or in parallel, or pairs of windings can be connected in parallel and the two pairs connected in series. Different numbers and groupings of windings can be used to provide machines having different numbers of phases and different power ratings etc.

In this example also, there are sixteen permanent magnets, however the number of magnets may vary and the ratio of magnets to windings may also vary and will determine number of phases and the number of windings per phase.

Round (circular cross-section) windings are used here as they are easy to manufacture and wind. However if arc-shaped or trapezoidal magnets had been used then greater power output could have been obtained. In this case the armature windings would preferably have been made with a corresponding arc-shaped or trapezoidal cross-section.

It can be seen, then, that the stator disc 12 has a plurality of discrete windings 24 mounted circumferentially thereon. The windings 24 are recessed into the stator disc and do not project into the air gap of the machine, and are thus less vulnerable to damage than the windings of conventional axial-flux, permanent magnet machines.

Usually in vertical axis wind turbines the generator is located on the shaft underneath the turbine blades. Mounting and dis-mounting generators in this position is very difficult as the turbine has to be supported in some way or removed all together. This problem can be avoided if the rotor and/or stator disc are made in two or more segments, in accordance with a further aspect of the invention.

Because the magnets are located at specific places in the rotor 10, the rotor disc could be made of two or more segments 30, 32 (see FIG. 7) and mounted onto a central collar 34. If required the central collar 34 could also be made in two halves which are then bolted together around the shaft. Bolting the two halves of the collar together would form a compression fit to the shaft 14.

As with the rotor 10, because of the discrete nature of the coils 24, the stator 12 could be divided into two or more segments and assembled round the shaft 14 in a manner similar to that described above for the rotor discs.

The above embodiments describe a rotor having a plurality of magnets being mounted thereon, and a stator that comprises windings. However, it is to be appreciated that the magnets could be mounted on the stator and that the rotor could be provided with windings. The foregoing principles of the invention are the same, and so detailed description of this alternative is therefore not necessary at this point.

Improvements and modifications may be incorporated without departing from the scope of the invention. In particular, it is to be recognised that the machine of the invention has a number of different uses. When used as a power generator, the generator can be used with a wind turbine, a water turbine or other types of apparatus.

### REFERENCES

1. Campbell, P.; “Principles of a permanent-magnet axial-field dc machine”, Proc IEE, 121, December 1974, pp1489-1494
2. Spooner E. and Chalmers, B. J.; “TORUS: A slotless, toroidal-stator, permanent-magnet generator”, IEE Proceedings, Part B, Vol. 139, No. 6, November 1992, pp 497-506
3. Brown, N., Scott, K., Lye, E., Bumby, J. R. and Spooner, E.: “A comparison of iron-cored and ironless axial-flux PM machines”, 36^{th} Universities Power Engineering Conference, Swansea, September 2001,
4. Chalmers, B. J., Wu, W. and Spooner, E., “An axial flux permanent magnet generator for a gearless wind energy system”, IEEE Trans. On Energy Conversion, Vol. 14, No. 3, June 1999, pp749-753
5. Brown, N., Haydock, L. and Bumby, J. R.: “A Toroidal, Axial Flux Generator for Hybrid IC engine/battery electric Vehicle Applications”, SAE 02p-308, March 2002
6. Ramsden, V. S., Mecrow, B. C., Lovatt, H. C. and Gwan, P.; “A high efficiency in-wheel drive motor for a solar-powered vehicle”, IEE Collogium on Electrical Machine Design for All-Electric and Hybrid-Electric Vehicles, Savoy Place, October 1999, pp 3/1-3/6.
7. Patterson, D. and Spee, R.; “The design and development of an axial flux permanent magnet brushless dc motor for wheel drive in a solar powered vehicle”, IEEE IAS Conf. Rec., Denver, Vol. 1, 1994, pp 188-195.
8. Pullen K. R., Mansir, H. and Fenocchi A.; “High power density air cooled motor generators for automotive applications”, IEE Power Division Coloquium on Electrical Machine Design for All-Electric and Huybrid-Electric Vehicles, Oct. 28, 1999

1. An axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having a plurality of discrete windings, the windings being mounted circumferentially on the stator or rotor disc and recessed into a surface of the stator or rotor disc.

2. The machine of claim 1, wherein the windings are wound on bobbin members.

3. The machine of claim 1, wherein the windings are embedded in the disc that has the windings.

4. The machine of claim 3, wherein the windings are fixed in place by a resin material.

5. The machine of claim 1, wherein at least one of the stator disc and the rotor disc is of segmented construction to facilitate assembly and dis-assembly of the discs to and from a supporting shaft.

6. The machine of claim 1, wherein the disc that has the windings is formed from a non magnetic, non-conducting material.

7. The machine of claim 6, wherein the non magnetic, non-conducting material is a plastics material.

8. The machine of claim 7, wherein the plastics material is PVC.

9. The machine of claim 7, wherein the plastics material is a resin material.

10. The machine of claim 1, wherein the windings are arranged in one or more groups, the windings of each group being inter-connected by switching means whereby the windings of each group may be selectively connected in series or in parallel.

11. The machine of claim 10, wherein the switching means further enables sub-groups of windings of each group to be connected in parallel and sub-groups to be connected together in series.

12. The machine of claim 1, wherein the rotor has a plurality of permanent magnets mounted circumferentially thereon and the stator has a plurality of discrete windings, the windings being mounted circumferentially on the stator disc and recessed into a surface of the stator disc.

13. An axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having at least one winding, wherein at least one of the stator disc and the rotor disc is of segmented construction to facilitate assembly and dis-assembly of the discs to and from a supporting shaft.

14. The machine of claim 13, wherein the rotor disc or stator disc that has the at least one winding has a plurality of discrete windings, the windings being mounted circumferentially on the stator or rotor disc and recessed into a surface of the stator or rotor disc.

15. The machine of claim 14, wherein the windings are wound on bobbin members.

16. The machine of claim 14, wherein the windings are embedded in the stator or rotor disc.

17. The machine of claim 16, wherein the windings are fixed in place by a resin material.

18. The machine of claim 13, wherein the rotor disc or stator disc that has the at least one winding is formed from a non-magnetic, non conducting material.

19. The machine of claim 18, wherein the non magnetic, non-conducting material is a plastics material.

20. The machine of claim 19, wherein the plastics material is PVC.

21. The machine of claim 19, wherein the plastics material is a resin material.

22. The machine of claim 13, wherein the windings are arranged in one or more groups, the windings of each group being inter-connected by switching means whereby the windings of each group may be selectively connected in series or in parallel.

23. The machine of claim 22, wherein the switching means further enables sub-groups of windings of each group to be connected in parallel and sub-groups to be connected together in series.

24. The machine of claim 13, wherein the rotor has a plurality of permanent magnets mounted circumferentially thereon and the stator has at least one winding.

25. An axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having at least one winding, wherein the rotor or stator disc is formed from a non-magnetic, non-conducting material.

26. The machine of claim 25, wherein the non-magnetic, non-conducting material is a plastics material.

27. The machine of claim 26, wherein the plastics material is PVC.

28. The machine of claim 26, wherein the plastics material is a resin material.

29. The machine of claim 25, wherein the rotor disc or stator disc that has the at least one winding has a plurality of discrete windings, the windings being mounted circumferentially on said rotor or stator disc and recessed into a surface of said rotor or stator disc.

30. The machine of claim 29, wherein the windings are wound on bobbin members.

31. The machine of claim 29, wherein the windings are embedded in the disc that has the at least one winding.

32. The machine of claim 31, wherein the windings are fixed in place by a resin material.

33. The machine of claim 25, wherein at least one of the stator disc and the rotor disc is of segmented construction to facilitate assembly and dis-assembly of the discs to and from a supporting shaft.

34. The machine of claim 25, wherein the windings are arranged in one or more groups, the windings of each group being inter-connected by switching means whereby the windings of each group may be selectively connected in series or in parallel.

35. The machine of claim 34, wherein the switching means further enables sub-groups of windings of each group to be connected in parallel and sub-groups to be connected together in series.

36. The machine of claim 25, wherein the rotor has a plurality of permanent magnets mounted circumferentially thereon and stator has at least one winding, wherein the stator disc is formed from a non-magnetic, non-conducting material.

37. An axial flux, permanent magnet electrical machine, comprising at least one generally planar stator disc and at least one generally planar rotor disc co-axial with the stator disc and mounted for rotation relative to the stator disc, one of the rotor or stator having a plurality of permanent magnets mounted circumferentially thereon and the other of the rotor or stator having a plurality of discrete windings mounted circumferentially thereon, the windings being arranged in one or more groups, the windings of each group being inter-connected by switching means whereby the windings of each group may be selectively connected in series or in parallel.

38. The machine of claim 37, wherein the switching means further enables sub-groups of windings of each group to be connected in parallel and sub-groups to be connected together in series.

39. The machine of claim 37, wherein the windings are mounted circumferentially on the: disc that has the plurality of windings and recessed into a surface of the disc that has the plurality of windings.

40. The machine of claim 39, wherein the windings are wound on bobbin members.

41. The machine of claim 39, wherein the windings are embedded in the disc that has the plurality of windings.

42. The machine of claim 41, wherein the windings are fixed in place by a resin material.

43. The machine of claim 37, wherein at least one of the stator disc and the rotor disc is of segmented construction to facilitate assembly and dis-assembly of the discs to and from a supporting shaft.

44. The machine of claim 37, wherein the disc that has the plurality of windings is formed from a non-magnetic, non-conducting material.

45. The machine of claim 44, wherein the non-magnetic, non-conducting material is a plastics material.

46. The machine of claim 45, wherein the plastics material is PVC.

47. The machine of claim 45, wherein the plastics material is a resin material.

48. The machine of claim 37, wherein the rotor has a plurality of permanent magnets mounted circumferentially thereon and the stator has a plurality of discrete windings mounted circumferentially on the stator disc.

49. A wind-turbine including a machine according to claim 1, said machine being configured as a power generator.

50. The wind turbine of claim 49, comprising a vertical axis shaft and a plurality of blades, the generator being located on said shaft below said blades.

51. The wind turbine of claim 49, comprising a horizontal axis shaft.
